(19) United States
(12) Patent Application Publication
(10) Pub. No.: US 2007/0147214 A1
(43) Pub. Date: Jun. 28, 2007

(54) Methods for storing holographic data and articles having enhanced data storage lifetime derived therefrom

(75) Inventors: Christoph Georg Erben, Clifton Park, NY (US); Eugene Pauling Boden, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/317,918

(22) Filed: Dec. 22, 2005

(51) Int. Cl. G11B 7/00

(52) U.S. Cl. 369/103

(57) ABSTRACT

A method of storing holographic data is provided. The method includes providing an optically transparent substrate comprising a photochemically active dye and a singlet-oxygen generator, irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element, and activating the optically transparent substrate to generate singlet oxygen to stabilize the optically readable datum.

### BACKGROUND

The present disclosure relates to methods for storing holographic data. Further, the present disclosure relates to holographic data storage media and articles having an enhanced data storage lifetime, which are derived from these methods.

Optical data storage technology has largely evolved on the basis of surface storage phenomena. In all surface-based optical data storage systems, each bit of data occupies a specific physical location in the storage medium. The data density of the optical media is therefore limited by physical constraints on the minimum size of a recording spot. An alternative approach to the traditional surface-based storage system is volumetric storage technology, in which the full volume of a storage medium is used to increase data capacity. The two most common techniques for volumetric storage are multi-layer and holographic. The multi-layer approach resembles the multiple-layer CD/DVD approach except that the data is written and retrieved using various optical phenomena that are sensitive to focused beams, so that various depths in the medium can be addressed by changing the depth of the focus. This technique eliminates the complexities of fabricating multiple layers and assembling them and, furthermore, removes the limitation on the number of layers, making it primarily a function of the focusing capabilities of the optical system.

In holographic storage, on the other hand, data is stored throughout the volume of the medium via three-dimensional or volume interference patterns. In the holographic recording process, holograms are recorded by the superposition of two beams within the volume of a photosensitive medium. The interference pattern from the superposition of the two beams results in a change or modulation of the refractive index of the holographic medium and are known as holograms. This modulation within the medium may serve to record both the intensity and phase information of the superposed beams.

Known holographic data storage techniques can be classified into page-based holographic data storage and bit-wise holographic data storage. In page-based holographic storage, data is written in “parallel”, on arrays or “pages” containing anywhere from one to 1×10⁶ or more bits. A signal beam, which contains digitally encoded data, is superposed on a reference beam within the medium, resulting in an interference pattern within the medium which in turn leads to corresponding changes in the refractive index. Each bit is generally stored as a part of the interference pattern that generates the index modulation over the volume of the holographic storage medium in a given spot, and can be thought of as consuming some small portion of the overall index modulation. The recorded intensity and phase data may then be retrieved by exposing the storage medium to the reference beam. A holographic storage medium that can support large index changes may consequently store multiple pages within the volume of the holographic medium by angular, wavelength, phase-code or related multiplexing techniques. In bit-wise holography or microholographic data storage, every bit is written as a microhologram or reflection gratings and is generated by two interfering counter-propagating focused beams. The data is retrieved by using a read beam to diffract off the microhologram to obtain a signal.

The heart of any holographic storage system is the storage medium. Recently, polymer dye-doped data storage materials for holographic data storage media have been developed. However, typically after data is written, subsequent data readout may quickly lead to erasure of the written information to such materials. Therefore, there is a need for techniques to enhance the lifetime of holographic data in a photochemically active dye based holographic medium.

### BRIEF DESCRIPTION

Disclosed herein are methods for storing holographic data in a storage medium having an enhanced data storage lifetime, and articles made using these methods.

In one aspect, the present invention provides a method for storing holographic data, said method comprising:

step (A) providing an optically transparent substrate comprising a photochemically active dye and a singlet-oxygen generator;

step (B) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and

step (C) activating the optically transparent substrate to generate singlet oxygen to stabilize the optically readable datum.

In still yet another aspect, the present invention provides an optical writing/reading method, said method comprising:

step (A) irradiating with a holographic interference pattern an optically transparent substrate that comprises a photochemically active dye and a singlet-oxygen generator, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing a first optically readable datum corresponding to the volume element; wherein the holographic interference pattern is produced by simultaneously irradiating the optically transparent substrate with a signal beam corresponding to data and a reference beam that does not correspond to data;

step (B) activating the optically transparent substrate to generate singlet oxygen to stabilize the optically readable datum; and

step (C) irradiating the optically transparent substrate with a read beam and reading the optically readable datum by detecting diffracted light.

In another aspect, the invention provides a method for forming a holographic data storage article is provided, said method comprising forming a film of an optically transparent substrate comprising an optically transparent plastic material, a photochemically active dye, and a singlet-oxygen generator.

In still yet another aspect, the present invention provides for a holographic data storage medium that can be used for storing data in the form of holograms. The data storage medium comprises an optically transparent plastic material, a photochemically active dye and a singlet-oxygen generator.

In another embodiment, the present invention provides for a data storage medium having at least one optically readable datum stored therein. The data storage medium comprises an optically transparent plastic material, a photochemically active dye, a singlet-oxygen generator, a photo-product derived from the photochemically active dye, a photo-stable product derived from the photochemically active dye, the photo-product, or combinations thereof; wherein the at least one optically readable datum is stored as a hologram patterned within at least one volume element of the optically transparent substrate included within the data storage medium.

These and other features, aspects, and advantages of the present invention may be understood more readily by reference to the following detailed description.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of holographic data storage and stabilizing in one embodiment of the present invention;

FIG. 2 is a schematic representation of a holographic data storage system in one embodiment of the present invention;

FIG. 3 is a schematic representation of a holographic data storage system in one embodiment of the present invention;

FIG. 4 is a schematic representation of a holographic data storage system in one embodiment of the present invention;

FIG. 5 is a graph illustrating the variation in absorbance with wavelength of a medium including a photochemically active dye, before and after a exposure to light of a specific wavelength, in one embodiment of the present invention;

FIG. 6 is a graph illustrating the variation in absorbance with wavelength of a medium including a photo-product of a photochemically active dye and a singlet oxygen sensitizer before and after exposure to light of a specific wavelength, in one embodiment of the present invention;

FIG. 7 is a graph illustrating the variation in absorbance with wavelength of a medium including a photo-stable product of a photo-product of a photochemically active dye before and after exposure to light of a specific wavelength, in one embodiment of the present invention;

FIG. 8 is a graph illustrating the variation in absorbance with wavelength of a medium including a photochemically active dye and a singlet oxygen sensitizer, before and after exposure to light of a specific wavelength, in one embodiment of the present invention.

### DETAILED DESCRIPTION

Some aspects of the present invention and general scientific principles used herein can be more clearly understood by referring to U.S. Patent Application 2005/0136333 (Ser. No. 10/742,461), which was published on Jun. 23, 2005; co-pending application having Ser. No. 10/954,779, filed on Sep. 30, 2004; and co-pending application having Ser. No. 11/260,806, filed on Oct. 27, 2005; all of which are incorporated herein in their entirety. It should be noted that with respect to the interpretation and meaning of terms in the present application, in the event of a conflict between this application and any document incorporated herein by reference, the conflict is to be resolved in favor of the definition or interpretation provided by the present application.

In the following specification and the claims which follow, reference will be made to a number of terms which shall be defined to have the following meanings.

The singular forms “a”, “an” and “the” include plural referents unless the context clearly dictates otherwise. As defined herein, the term “volume element” means a three dimensional portion of the total volume of an optically transparent substrate.

As used herein the term “aliphatic radical” refers to an organic radical having a valence of at least one consisting of a linear or branched array of atoms that is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH2)₉—) is an example of a C₁₀ aliphatic radical.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical that comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂C₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein, the terms “photochemically reactive” and “photochemically active” have the same meaning and are interchangeable terms.

As defined herein, the term “photo-stable product” refers to a reaction product which shows greater photostability than a corresponding photochemically active chemical species from which it was derived. For example, oxidation of a photochemically active closed-form diarylethylene dye (photo-product of open-form diarylethene) affords as a reaction product, the corresponding oxidized closed-form diarylethene. The oxidized closed form diarylethene is a “photo-stable product” because it shows greater photostability on average than does the open form photochemically active diarylethene dye from which it was derived.

As defined herein, the term “optically transparent substrate” denotes a combination of an optically transparent plastic material and at least one photochemically active dye, which has an absorbance of less than 1, that is, at least 10 percent of incident light is transmitted through the material at least one wavelength in a range from about 300 nanometers to about 800 nanometers (hereinafter “nm”).

As defined herein, the term “optically transparent plastic material” means a substrate which has an absorbance of less than 1, that is, at least 10 percent of incident light is transmitted through the material at least one wavelength in a range from about 300 nm to about 800 nm.

As defined herein, the term “volume element” means a three dimensional portion of a total volume.

As defined herein, the term “optically readable datum” can be understood as a datum that is stored as a hologram patterned within one or more volume elements of an optically transparent substrate.

As used herein, the term “enhanced lifetime” refers to an increased number of read-out cycles of the optically readable datum.

The refractive index within an individual volume element may be constant throughout the volume element, as in the case of a volume element that has not been exposed to electromagnetic radiation, or in the case of a volume element in which the photochemically active dye has been reacted to the same degree throughout the volume element. It is believed that most volume elements that have been exposed to electromagnetic radiation during the holographic data writing process will contain a complex holographic pattern, and as such, the refractive index within the volume element will vary across the volume element. In instances in which the refractive index within the volume element varies across the volume element, it is convenient to regard the volume element as having an “average refractive index” which may be compared to the refractive index of the corresponding volume element prior to irradiation. Thus, in one embodiment an optically readable datum comprises at least one volume element having a refractive index that is different from a (the) corresponding volume element of the optically transparent substrate prior to irradiation. Data storage is achieved by locally changing the refractive index of the data storage medium in a graded fashion (continuous sinusoidal variations), rather than discrete steps, and then using the induced changes as diffractive optical elements.

As defined herein, the term M/# denotes the capacity of a data storage medium, and can be measured as a function of the total number of multiplexed holograms that can be recorded at a volume element of the data storage medium at a given diffraction efficiency. M/# depends upon various parameters, such as the change in refractive index (Δn), the thickness of the medium, and the dye concentration. The M/# is defined as shown in equation (1):

$$M / \# = {\sum }_{i = 1}^{N} \sqrt{{η}_{i}} \qquad Equation ( 1 )$$

where ηᵢ is diffraction efficiency of the i^{th} hologram, and N is the number of recorded holograms. The experimental setup for M/# measurement for a test sample at a chosen wavelength, for example, at 532 nanometer or 405 nanometers involves positioning the testing sample on a rotary stage that is controlled by a computer. The rotary stage has a high angular resolution of about 0.0001 degree. An M/# measurement involves two steps: recording and readout. At recording, multiple plane wave holograms are recorded at the same location on the same sample. A plane wave hologram is a recorded interference pattern produced by a signal beam and a reference beam. The signal and reference beams are coherent to each other. They are both plane waves that have the same power and beam size, incident at the same location on the sample, and polarized in the same direction. Multiple plane wave holograms are recorded by rotating the sample. Angular spacing between two adjacent holograms is about 0.2 degree. This spacing is chosen so that their impact to the previously recorded holograms, when multiplexing additional holograms, is minimal and at the same time, the usage of the total capacity of the media is efficient. Recording time for each hologram is generally the same in M/# measurements. At readout, the signal beam is blocked. The diffracted signal is measured using the reference beam and an amplified photo-detector. Diffracted power is measured by rotating the sample across the recording angle ranges with a step size of about 0.004 degree. The power of the reference beam used for readout is typically about 2-3 orders of magnitude smaller than that used at recording. This is to minimize hologram erasure during readout while maintaining a measurable diffracted signal. From the diffracted signal, the multiplexed holograms can be identified from the diffraction peaks at the hologram recording angles. The diffraction efficiency of the i^{th} hologram, η_{i,}, is then calculated by using equation (2):

$${η}_{i} = \frac{{P}_{i , diffracted}}{{P}_{reference}} \qquad Equation ( 2 )$$

where P_{i, diffracted} is the diffracted power of the i^{th} hologram. M/# is then calculated using the diffraction efficiencies of the holograms and equation (1). Thus, a holographic plane wave characterization system may be used to test the characteristics of the data storage material, especially multiplexed holograms. Further, the characteristics of the data storage material can also be determined by measuring the diffraction efficiency.

The capacity to store data as holograms (M/#) is also directly proportional to the ratio of the change in refractive index per unit dye density (Δn/N0) at the wavelength used for reading the data to the absorption cross section (σ) at a given wavelength used for writing the data as a hologram. The refractive index change per unit dye density is given by the ratio of the difference in refractive index of the volume element before irradiation minus the refractive index of the same volume element after irradiation to the density of the dye molecules. The refractive index change per unit dye density has a unit of (centimeter)³. Thus in an embodiment, the optically readable datum comprises at least one volume element wherein the ratio of the change in the refractive index per unit dye density of the at least one volume element to an absorption cross section of the at least one photochemically active dye is at least about 10⁻⁵ expressed in units of centimeter.

Sensitivity (S) is a measure of the diffraction efficiency of a hologram recorded using a certain amount of light fluence (F). The light fluence (F) is given by the product of light intensity (I) and recording time (t). Mathematically, sensitivity is given by equation (3),

$$S = \frac{\sqrt{η}}{I \cdot t \cdot L} ( cm / J ) \qquad Equation ( 3 )$$

wherein I is the intensity of the recording beam, “t” is the recording time, L is the thickness of the recording (or data storage) medium (example, disc), and η is the diffraction efficiency. Diffraction efficiency is given by equation (4),

$$η = {sin}^{2} ( \frac{π \cdot Δ n \cdot L}{λ \cdot cos ( θ )} ) \qquad Equation ( 4 )$$

wherein λ is the wavelength of light in the recording medium, θ is the recording angle in the media, and Δn is the refractive index contrast of the grating, which is produced by the recording process, wherein the dye molecule undergoes a photochemical conversion.

The absorption cross section is a measurement of the ability of an atom or molecule to absorb light at a specified wavelength, and is measured in square centimeter/molecule. It is generally denoted by σ(λ) and is governed by the Beer-Lambert Law for optically thin samples as shown in Equation (5),

$$σ ( λ ) = ln ( 10 ) \cdot \frac{Absorbance ( λ )}{{N}_{o} \cdot L} ( {cm}^{2} ) \qquad Equation ( 5 )$$

wherein N₀ is the concentration in molecules per cubic centimeter, and L is the sample thickness in centimeters.

Quantum efficiency (QE) is a measure of the probability of a photochemical transition for each absorbed photon of a given wavelength. Thus, it gives a measure of the efficiency with which incident light is used to achieve a given photochemical conversion, also called as a bleaching process. QE is given by equation (6),

$$QE = \frac{hc / λ}{σ \cdot {F}_{0}} \qquad Equation ( 6 )$$

wherein “h” is the Planck's constant, “c” is the velocity of light, σ(λ) is the absorption cross section at the wavelength λ, and F₀ is the bleaching fluence. The parameter F₀ is given by the product of light intensity (I) and a time constant (τ) that characterizes the bleaching process.

The photochemically active dye is one which renders the optically transparent substrate capable of having holograms “written” into it at a first wavelength. And further, the photochemically active dye should be such that a hologram having been “written” into the optically transparent substrate at a first wavelength is not erased when the hologram is “read”. It is desirable to use dyes that enable “writing” of the holographic interference pattern into the optically transparent substrate at wavelengths in a range from about 300 nm to about 1,500 nm.

In one embodiment, the photochemically active dye has an optical absorption resonance characterized by a center wavelength associated with the maximum absorption and a spectral width (full width at half of the maximum, FWHM) of less than 500 nanometers. Typically, the photochemically active dyes undergo a light induced chemical reaction when exposed to light with a wavelength within the absorption range to form at least one photo-product. This reaction can be a photo-decomposition reaction, such as oxidation, reduction, or bond breaking to form smaller constituents, or a molecular rearrangement, such as a sigmatropic rearrangement, or addition reactions including pericyclic cycloadditions. Thus in an embodiment, data storage in the form of holograms is achieved wherein a photo-product is patterned (for example, in a graded fashion) within the optically transparent substrate to provide the at least one optically readable datum.

In an embodiment, the photochemically active dye is a vicinal diarylethene. In another embodiment, the photochemically active dye is a photo-product resulting from a photochemically active dye, such as for example, a product resulting from photochemical cyclization of a diarylethene that is capable of cyclizing; or a product resulting from ring opening of a vicinal diarylethene that is capable of ring opening. In still another embodiment, the photochemically active dye is a nitrostilbene. In still yet another embodiment, the photochemically active dye is a nitrone. In one embodiment, a combination comprising two or more photochemically active dyes selected from the group consisting of a vicinal diarylethene, a nitrone, a photo-product derived from a vicinal diarylethene, and a nitrostilbene is used.

Photochemically active diarylethenes are particularly useful compounds for producing holographic data storage articles. In an embodiment, the photochemically active diarylethene has desirable optical properties, such as a relatively low absorption cross-section while having a relatively high refractive index change and/or relatively high quantum efficiency for the photo-induced reaction. High quantum efficiency also leads to a higher sensitivity since sensitivity is directly proportional to the product of quantum efficiency and refractive index change (defined as Δn). Writing of data as a hologram into the optically transparent substrate comprising the photochemical active dye is due to the dye undergoing a partial photochemical conversion at the write wavelength, thereby producing a modified optically transparent substrate comprising at least one optically readable datum. The “write wavelength” corresponds to the wavelength of the holographic interference pattern which is used to irradiate the optically transparent substrate. The sensitivity of a dye-doped data storage material (here, an optically transparent substrate comprising a photochemically reactive dye) is dependent upon the concentration of the dye (N₀), the dye's absorption cross-section at the recording wavelength, the quantum efficiency QE of the photochemical transition, and the index change of the dye molecule for a unit dye density (Δn₀/N₀). However, as the product of dye concentration and the absorption cross-section increases, the dye-doped storage material tends to become opaque, which inhibits both recording and readout. Therefore, in an embodiment, photochemically active compounds of interest for achieving high M/#s are those materials that undergo an efficient photochemical transformation accompanied with a high refractive index change and a high quantum efficiency at the wavelength that is used for writing data, one that is removed from the main UV-visible absorption peak of the dye.

Embodiments of the present invention provide methods and articles for optical holographic data storage. In one embodiment of the present invention is a method for storing holographic data. The method comprises irradiating an optically transparent substrate comprising a photochemically active dye with a holographic interference pattern. The holographic interference pattern has a first wavelength and an intensity that are sufficient to convert, within a volume element of the substrate being irradiated, at least some of the photochemically active dye into a photo-product, and producing within the irradiated volume element concentration variations of the photo-product corresponding to the holographic interference pattern. An optically readable datum corresponding to the volume element is produced thereby. After the optically readable datum has been written into the optically transparent substrate, the optically transparent substrate is activated to generate singlet oxygen to stabilize the optically readable datum.

In one embodiment, the irradiation facilitates a partial chemical conversion (also sometimes referred to as “reaction”) of the photochemically active dye to a photo-product, for example, the cyclization reaction of the vicinal diarylethene to a cyclized product, or the ring opening reaction of the cyclized product to the vicinal diarylethene product, or conversion of an aryl nitrone to an aryl oxaziridine product; or a decomposition product derived from the oxaziridine, thereby creating a hologram of the optically readable datum. In one embodiment of the present invention, the refractive index change from a photochemically active dye to a photo-product is greater than or equal to about 10⁻³. In a further embodiment, the refractive index change is greater than or equal to about 10⁻⁴.

Those skilled in the art will appreciate that the lingering photosensitivity of photo-products and the residual (unconverted) photochemically reactive dye can adversely affect the integrity of the stored data if no step is taken to stabilize the photo-products and the unconverted photochemically reactive dye. The method further includes reacting the photo-product with singlet oxygen to generate a photo-stable product. In one embodiment, the singlet oxygen is provided by including a singlet oxygen generator in the optically transparent substrate and activating the singlet oxygen generator to provide singlet oxygen. Singlet oxygen generated may react with a photo-product as discussed above or alternatively may react with a photochemically active dye to generate a photo-stable product.

As used herein, the term “singlet oxygen generator” refers both to compounds, which dissociate upon activation to release singlet oxygen (hereinafter “singlet oxygen precursors”) and to compounds, which upon photosensitization, enable the conversion of triplet state molecular oxygen to singlet oxygen (hereinafter “singlet oxygen sensitizers”).

Typically upon photosensitization, a singlet oxygen sensitizer is excited to its singlet excited state, which is followed by conversion (referred to as intersystem crossing) to its triplet excited state. The triplet excited sensitizer then interacts with triplet oxygen in its surroundings to produce singlet oxygen. Non-limiting examples include methylene blue, azulene, rose bengal, 2′-acetonaphthone, acridine, 9-methyl-anthracene, coronene, naphthalene, and naphthalocyanine. Examples of singlet oxygen sensitizers are described in many references including, “Journal of Physical and Chemical Reference data, volume 22, pages 113-262”, which is incorporated herein in its entirety.

A singlet oxygen precursor upon photo or thermal activation dissociates to produce molecular oxygen in its singlet state. Non limiting examples include phosphite ozonides, and aromatic endoperoxides such as naphthalene endoperoxides and anthracene endoperoxides. Examples of naphthalene endoperoxide include but are not limited to 1,4-disubstituted naphthalene peroxide, and N,N′-di(2,3-dihydroxypropyl)-1,4-naphthalenedipropanamide. Examples of anthracene endoperoxides include but are not limited to 9,10-diphenylanthracene peroxide, 1,4,-diphenylanthracene peroxide.

In one embodiment, the step of activating is accomplished by photo-activating at a second wavelength and an intensity sufficient to generate singlet oxygen, wherein the singlet oxygen reacts with the photo-product and the photochemically active dye to stabilize the optically readable datum. In another embodiment, the step of activating is accomplished by thermally activating with thermal energy sufficient to generate singlet oxygen, wherein the singlet oxygen reacts with the photo-product and the photochemically active dye to stabilize the optically readable datum.

Examples of suitable diarylethenes that can be used as photochemically active dyes include but are not limited to diarylperfluorocyclopentenes, diarylmaleic anhydrides, diarylmaleimides, or a combination comprising at least one of the foregoing diarylethenes. The vicinal diarylethenes can be prepared using methods known in the art. The diarylethenes are present as open-ring or closed-ring isomers. In general, the open ring isomers of diarylethenes have absorption bands at shorter wavelengths. Upon irradiation with ultraviolet light, new absorption bands appear at longer wavelengths, which are ascribed to the closed-ring isomers. The absorption spectra of the open and closed-ring isomers may depend on the substituents of the thiophene rings, naphthalene rings or the phenyl rings. The absorption structures of the open and closed-ring isomers may depend upon the upper cycloalkene structures. For example, the open-ring isomers of maleic anhydride or maleimide derivatives show spectral shifts to longer wavelengths in comparison with the perfluorocyclopentene derivatives.

An exemplary class of vicinal diarylethene compounds can be represented by generic structure (I), 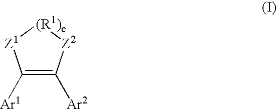
wherein “e” is 0 or 1; R¹ is a bond, an oxygen atom, a substituted nitrogen atom, a sulfur atom, a selenium atom, a divalent C₁-C₂₀ aliphatic radical, a halogenated divalent C₁-C₂₀ aliphatic radical, a divalent C₃-C₂₀ cycloaliphatic radical, a halogenated divalent C₁-C₂₀ cycloaliphatic radical, or a divalent C₂-C₃₀ aromatic radical; Ar¹ and Ar² are each independently a C₂-C₄₀ aromatic radical, or a C₂-C₄₀ heteroaromatic radical; and Z¹ and Z² are independently a bond, a hydrogen atom, a monovalent C₁-C₂₀ aliphatic radical, divalent C₁-C₂₀ aliphatic radical, a monovalent C₃-C₂₀ cycloaliphatic radical, a divalent C₃-C₂₀ cycloaliphatic radical, a monovalent C₂-C₃₀ aromatic radical, or a divalent C₂-C₃₀ aromatic radical. It should be noted that each of the aromatic radicals Ar¹ and Ar² are identical or different as are the groups Z¹ and Z². It will be understood by those skilled in the art that Ar¹ may differ in structure from Ar² and that Z¹ may differ in structure from Z², and that such species are encompassed within generic structure I and are included within the scope of the instant invention.

In another embodiment, e is 0, and Z¹ and Z² C₁-C₅ alkyl, C₁-C₅ perfluoroalkyl, or CN. In still another embodiment, e is 1, and Z¹ and Z² are independently CH₂, CF₂, or C═O. In yet another embodiment, Ar¹ and Ar² are each independently an aromatic radical selected from the group consisting of phenyl, anthracenyl, phenanthrenyl, pyridinyl, pyridazinyl, 1H-phenalenyl and naphthyl, optionally substituted by one or more substituents, wherein the substituents are each independently C₁-C₃ alkyl, C₁-C₃ perfluoroalkyl, C₁-C₃ alkoxy, or fluorine. In yet another embodiment at least one of Ar¹ and Ar² comprises one or more aromatic moieties selected from the group consisting of structures (II), (III), and (IV), 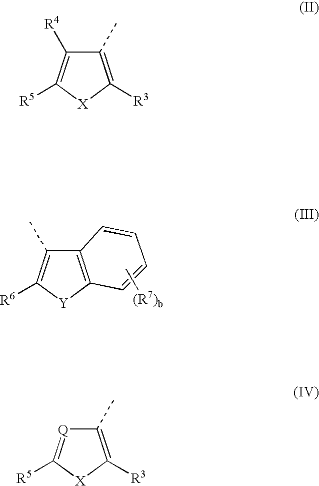
wherein R³, R⁴, R⁵, and R⁶ are hydrogen, a halogen atom, a nitro group, a cyano group, a C₁-C₁₀ aliphatic radical, a C₃-C₁₀ cycloaliphatic radical, or a C₂-C₁₀ aromatic radical; R⁷ is independently at each occurrence a halogen atom, a nitro group, a cyano group, a C₁-C₁₀ aliphatic radical, a C₃-C₁₀ cycloaliphatic radical, or a C₂-C₁₀ aromatic radical; “b” is an integer from and including 0 to and including 4; X and Y are selected from the group consisting of sulfur, selenium, oxygen, NH, and nitrogen substituted by a C₁-C₁₀ aliphatic radical, a C₃-C₁₀ cycloaliphatic radical, or a C₂-C₁₀ aromatic radical; and Q is CH or N. In one embodiment, at least one of R³, R⁴, R⁵, and R⁶ is selected from the group consisting of hydrogen, fluorine, chlorine, bromine, C₁-C₃ alkyl, C₁-C₃ perfluoroalkyl, cyano, phenyl, pyridyl, isoxazolyl, —CHC(CN)₂.

The vicinal diarylethenes can be reacted in the presence of actinic radiation (i.e. radiation that can produce a photochemical reaction), such as light. In one embodiment, an exemplary vicinal diarylethene can undergo a reversible cyclization reaction in the presence of light (hν) according to the following equation (4): 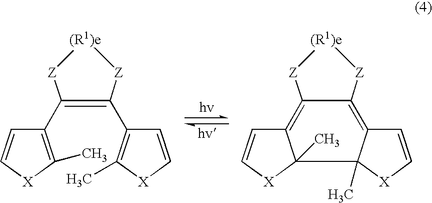
where X, Z R¹ and e have the meanings indicated above. The cyclization reactions can be used to produce holograms. The holograms can be produced by using radiation to effect the cyclization reaction or the reverse ring-opening reaction. The cyclization reaction is a photochromic reaction, whereby a form change results in change in refractive index. Typically hν′ is lower in energy (longer wavelength) than hν. Typically if the cyclization reaction is initiated at a ultra violet wavelength, then the reverse ring opening reaction typically occurs at a visible or infrared wavelength.

As described above, cyclization reactions can be used to produce holograms. The holograms can be produced by using radiation to effect the cyclization reaction or the reverse ring-opening reaction. Thus, in an embodiment, a photo-product derived from a vicinal diarylethene can be used as a photochemically active dye. Such photo-products derived from the vicinal diarylethene can be represented by a formula (V), 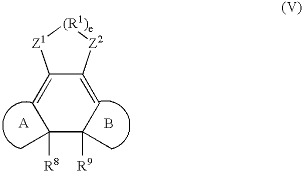
wherein “e”, R¹, Z¹, and Z² are as described for the vicinal diarylethene having formula (I), A and B are fused rings, and R⁸ and R⁹ are each independently a hydrogen atom, an aliphatic radical, a cycloaliphatic radical, or an aromatic radical. One or both fused rings A and B may comprise carbocyclic rings which do not have heteroatoms. In another embodiment, the fused rings A and B may comprise one or more heteroatoms selected from the group consisting of oxygen, nitrogen, and sulfur.

Other photochemically active dye such as nitrones and nitrostilbenes may also be used along with vicinal diarylethenes. The photochemically active dye may be a α-aryl-N-arylnitrone or a conjugated analog thereof in which the conjugation is between the aryl group and an α-carbon atom. The α-aryl group is frequently substituted, often by a dialkylamino group, in which the alkyl groups contain 1 to about 4 carbon atoms. Suitable, non-limiting examples of nitrones include α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-(4-Dimethylamino)styryl-N-phenyl Nitrone, α-Styryl-N-phenyl nitrones, α-[2-(1,1-diphenylethenyl)]-N-phenylnitrone, α-[2-(1-phenylpropenyl)]-N-phenylnitrone, or a combination comprising at least one of the foregoing nitrones.

Examples of nitrostilbenes include but are not limited to 4-dimethylamino-2′,4′-dinitrostilbene, 4-dimethylamino-4′-cyano-2′-nitrostilbene, 4-hydroxy-2′,4′-dinitrostilbene, and the like.

The photochemically active dye is one that enables both the writing of and reading of holographic data using electromagnetic radiation. Those skilled in the art will appreciate that the dye undergoes a photochemical transformation during the writing process resulting in concentration variations of the dye within the holographic storage medium, said concentration variations being referred to as holograms. It is desirable to use dyes that can be written to (write beam) and read from (read beam) using actinic radiation i.e., radiation having a wavelength from about 300 nm to about 1,100 nm. The wavelengths at which writing and reading are accomplished are about 300 nm to about 800 nm. In one embodiment, writing and reading are accomplished at a wavelength of about 400 nm to about 600 nm. In another embodiment, writing and reading are accomplished at a wavelength of about 400 to about 550 nanometers. In still another embodiment, the reading wavelength is such that it is shifted by 0 nm to about 400 nm from the writing wavelength. Exemplary wavelengths at which writing and reading are accomplished are about 405 nanometers and about 532 nanometers. In an embodiment, the optically transparent substrate is irradiated with a holographic interference pattern having first wavelength to record data. The optically transparent substrate is then irradiated with radiation having a second wavelength to stabilize the written data, and the stabilized data can then be read using radiation having a third wavelength (e.g., a “read beam”), wherein the radiation at each step can independently have a wavelength from about 300 nm to about 1,500 nm. In an embodiment, the first, second, and third wavelengths can be independently between about 300 nm and about 1500 nm. In one embodiment, the first wavelength (or the writing wavelength) for writing and recording the data onto the holographic data storage medium is from about 375 nm to about 450 nm. In another embodiment, the first wavelength can be from about 355 nm to about 550 nm. In one embodiment, the first wavelength is in a range from about 375 nm to about 450 nm and the second wavelength is in a range from about 450 to about 1500 nm. In another embodiment, the first wavelength is in a range from about 450 nm to about 550 nm and the second wavelength is in a range from about 550 to about 1500 nm. In still another embodiment, the writing wavelength is such that it is shifted by 0 nm to about 600 nm from the wavelength at which the recorded data is stabilized by the action of light of the second wavelength. Exemplary wavelengths at which writing and data stabilization are accomplished are about 405 nanometers (writing) and about 780 nanometers (stabilization).

In one embodiment, the photochemically active dye is present in an amount from about 0.1 to about 10 weight percent, based on the total weight of the optically transparent substrate, and the optically transparent substrate has a UV-visible absorbance in a range between about 0.1 and about 1 at least one wavelength in a range between about 300 nm and about 800 nm. The singlet oxygen generator is present in a molar quantity similar to or greater than the molar quantity of the photochemically active dye. Such photochemically active dyes may be used in combination with other materials, such as, for example, binders to form photo-active materials, which in turn are used for manufacturing holographic data storage media. In an embodiment, a film of an optically transparent substrate comprising an optically transparent plastic material and a photochemically active dye and a singlet oxygen generator is formed. Generally, the film is prepared by molding techniques by using a molding composition that is obtained by mixing the dye, singlet oxygen generator with an optically transparent plastic material.

The optically transparent plastic materials used in producing the holographic data storage media can comprise any plastic material having sufficient optical quality, e.g., low scatter, low birefringence, and negligible losses at the wavelengths of interest, to render the data in the holographic storage material readable.

Organic polymeric materials, such as for example, oligomers, polymers, dendrimers, ionomers, copolymers such as for example, block copolymers, random copolymers, graft copolymers, star block copolymers; or the like, or a combination comprising at least one of the foregoing polymers can be used. Thermoplastic polymers or thermosetting polymers can be used. Examples of suitable thermoplastic polymers include polyacrylates, polymethacrylates, polyamides, polyesters, polyolefins, polycarbonates, polystyrenes, polyesters, polyamideimides, polyarylates, polyarylsulfones, polyethersulfones, polyphenylene sulfides, polysulfones, polyimides, polyetherimides, polyetherketones, polyether etherketones, polyether ketone ketones, polysiloxanes, polyurethanes, polyarylene ethers, polyethers, polyether amides, polyether esters, or the like, or a combination comprising at least one of the foregoing thermoplastic polymers.

Organic polymers that are not transparent to electromagnetic radiation can also be used in the binder composition if they can be modified to become transparent. For examples, polyolefins are not normally optically transparent because of the presence of large crystallites and/or spherulites. However, by copolymerizing polyolefins, they can be segregated into nanometer-sized domains that cause the copolymer to be optically transparent.

In one embodiment, the organic polymer can be chemically attached to the photochemically active dye. The photochemically active dye can be attached to the backbone of the polymer. In another embodiment, the photochemically active dye can be attached to the polymer backbone as a substituent. The chemical attachment can include covalent bonding, ionic bonding, or the like.

Some more possible examples of suitable thermoplastic polymers include, but are not limited to, amorphous and semi-crystalline thermoplastic polymers and polymer blends, such as: polyvinyl chloride, linear and cyclic polyolefins, chlorinated polyethylene, polypropylene, and the like; hydrogenated polysulfones, ABS resins, hydrogenated polystyrenes, syndiotactic and atactic polystyrenes, polycyclohexyl ethylene, styrene-acrylonitrile copolymer, styrene-maleic anhydride copolymer, and the like; polybutadiene, polymethylmethacrylate (PMMA), methyl methacrylate-polyimide copolymers; polyacrylonitrile, polyacetals, polyphenylene ethers, including, but not limited to, those derived from 2,6-dimethylphenol and copolymers with 2,3,6-trimethylphenol, and the like; ethylene-vinyl acetate copolymers, polyvinyl acetate, ethylene-tetrafluoroethylene copolymer, aromatic polyesters, polyvinyl fluoride, polyvinylidene fluoride, and polyvinylidene chloride.

In some embodiments, the thermoplastic polymer used in the methods disclosed herein as a substrate is made of a polycarbonate. The polycarbonate may be an aromatic polycarbonate, an aliphatic polycarbonate, or a polycarbonate comprising both aromatic and aliphatic structural units.

Polycarbonates can be produced by any of the methods known in the art. Branched polycarbonates are also useful, as well as blends of linear polycarbonates and branched polycarbonates. Preferred polycarbonates are based on bisphenol A. Preferably, the weight average molecular weight of the polycarbonate is about 5,000 to about 100,000 atomic mass units, more preferably about 10,000 to about 65,000 atomic mass units, and most preferably about 15,000 to about 35,000 atomic mass units. Other specific examples of a suitable thermoplastic polymer for use in forming the holographic data storage media include Lexan®, a polycarbonate; and Ultem®, an amorphous polyetherimide, both of which are commercially available from General Electric Company.

Examples of useful thermosetting polymers include those selected from the group consisting of an epoxy, a phenolic, a polysiloxane, a polyester, a polyurethane, a polyamide, a polyacrylate, a polymethacrylate, or a combination comprising at least one of the foregoing thermosetting polymers.

The photochemically active dye may be admixed with other additives to form a photo-active material. Examples of such additives include heat stabilizers; antioxidants; light stabilizers; plasticizers; antistatic agents; mold releasing agents; additional resins; binders, blowing agents; and the like, as well as combinations of the foregoing additives. The photo-active materials are used for manufacturing holographic data storage media.

Cycloaliphatic and aromatic polyesters can be used as binders for preparing the photo-active material. These are suitable for use with thermoplastic polymers, such as polycarbonates, to form the optically transparent substrate. These polyesters are optically transparent, and have improved weatherability, low water absorption and good melt compatibility with the polycarbonate matrix. Cycloaliphatic polyesters are generally prepared by reaction of a diol with a dibasic acid or an acid derivative, often in the presence of a suitable catalyst.

Generally, the polymers used for forming the optically transparent substrate, and the holographic data storage medium should be capable of withstanding the processing parameters, such as for example during the step of including the dye and application of any coating or subsequent layers and molding into final format; and subsequent storage conditions. Suitable thermoplastic polymers have glass transition temperatures of about 100° C. or greater in an embodiment, about 150° C. or greater in another embodiment, and about 200° C. or greater in still another embodiment. Exemplary thermoplastic polymers having glass transition temperatures of 200° C. or greater include certain types of polyetherimides, polyimides, and combinations comprising at least one of the foregoing.

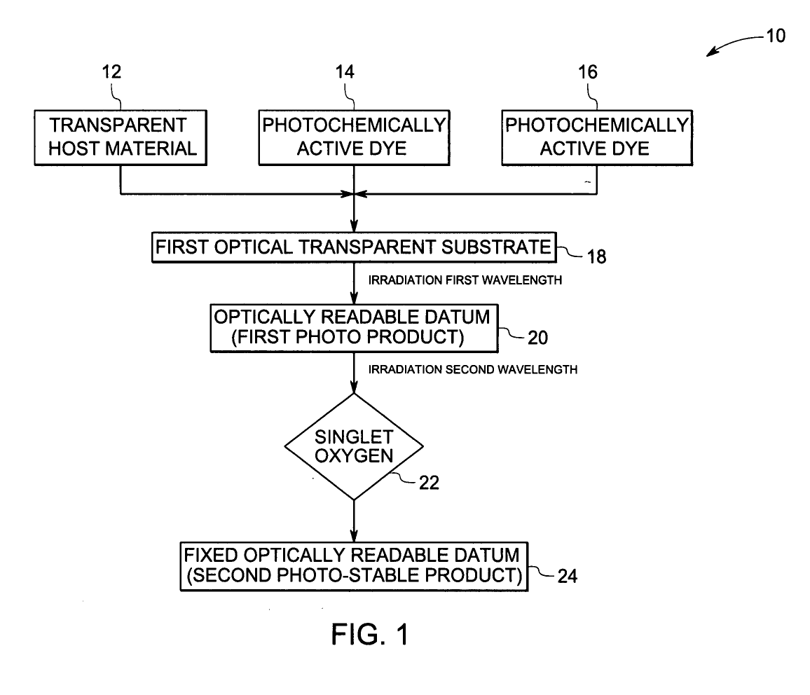

FIG. 1 illustrates the process 10 for holographic data storage and holographic data stabilizing in one embodiment of the present invention. A holographic storage medium comprises a first optical transparent substrate 18 and includes a transparent host material 12, a photochemically active dye material 14 and a singlet oxygen generator material 16. Upon irradiation at a first wavelength, the photochemically active dye 14 is converted to a first photo-product to provide an optically readable datum 20. A singlet oxygen generator generates singlet oxygen 22 upon activation with a second wavelength. Non-limiting examples of singlet oxygen generators include singlet oxygen sensitizers or singlet oxygen precursors or combinations thereof. (In alternate embodiments, activation to produce singlet oxygen from the singlet oxygen generator may take place by photo-activation or thermal activation.) Upon generation of singlet oxygen, the singlet oxygen 22 reacts with the first photo-product 20 and may also react with the photochemically active dye 14 to result in at least a first photo-stable product 24 (stabilized optically readable datum). In some embodiments, the process of stabilizing may be carried out in a holographic medium as a whole or in a small portion or volume of the holographic medium at a given time. Stabilizing only a portion of the holographic medium including data allows for the possibility of writing additional data to the holographic medium in the future.

In some embodiments, activation time or exposure time of the medium to a source of activation, such as heat, or light and oxygen, or a combination of heat and light and oxygen, is less than or about 60 seconds. In some other embodiments, the activation time is less than or about to 30 seconds. In still other embodiments, the activation time is less than or about 10 seconds. In one embodiment, the activation time is in a range from about 1 minute to about 10 minutes. In some embodiments, more than one source of activation, for example photo- and thermal-activation may simultaneous or in succession be applied to activate the data stabilization process.

In a non-limiting example of writing and stabilizing holographic data, an open form diarylethene, 1,2-bis[5′-(4″-hydroxyphenyl)-2′-methylthien-3′-yl]perfluorocyclopentene (DAEOHₒ) represented by formula (VI), was photochemically transformed as shown in equation 7 to form a closed form diarylethene (DAEOH_{c}) represented by formula (VII), upon irradiation at a wavelength of about 405 nanometer. The DAEOH_{c} has a refractive index n_{c} not equal to the refractive index nₒ of the DAEOHₒ. In one embodiment, the refractive index change between open and closed isomers of diarylethene is greater than about 10⁻³. In another embodiment, the refractive index change between open and closed isomers of diarylethene is greater than about 10⁻⁴.

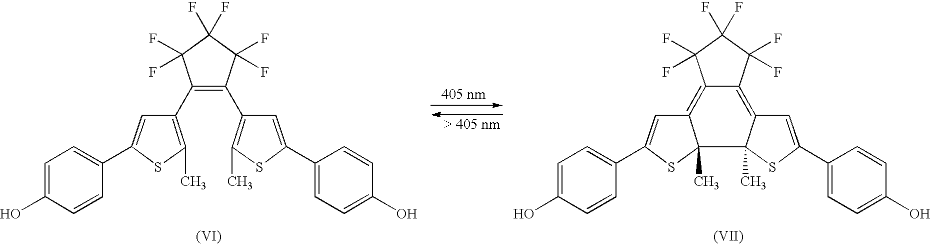

To prevent the reverse reaction from the DAEOH_{c} to the DAEOHₒ, the DAEOH_{c} is subjected to an oxidation reaction, whereby the phenolic group is oxidized to a keto-group. In one embodiment of the present invention, a singlet oxygen sensitizer (SOS), Zinc 2,11,20,29-tetra-tert-butyl-2,3-naphthalocyanine (hereinafter “ZnNa”), CAS # 39049-43-9, available from Aldrich Chem. Co., is used to generate singlet oxygen, which reacts with the diarylethene to oxidize DAEOH_{c}. In one embodiment, the photosensitization of ZnNa leading to generation of singlet oxygen is performed at a wavelength greater than 405 nm. In another embodiment, the photosensitization of ZnNa leading to generation of singlet oxygen is performed at a wavelength greater than 600 nm. The refractive index n_{oxc} of the oxidized DAEOH_{c} (DAEO_{c}) shown in formula (VIII), is comparable to n_{c} and further, the (DAEO_{c}) does not undergo photochemical reactions at the read and write wavelengths. Therefore the holographic data is preserved and repeated read outs at the read wavelength does not destroy the holographic data. Therefore, the holographic data is stable and stabilized with respect to the read/write wavelengths.

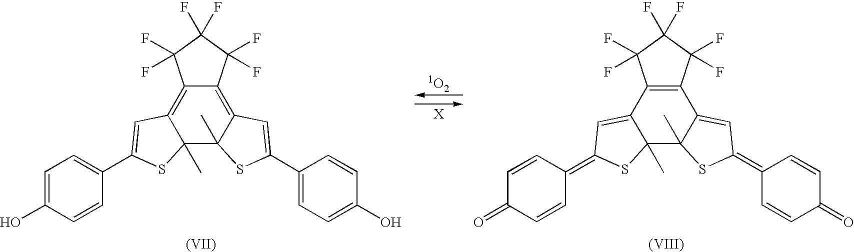

As discussed above, it is further advantageous to fix any residual dye in a portion or whole medium, if no further writing is expected in a portion or whole of the medium respectively. The step of generating singlet oxygen apart from stabilizing the DAEOH_{c} also enables the stabilization of the DAEOHₒ. Singlet oxygen can also interact with DAEOHₒ leading to the formation of photo-stable products as shown in equation 9. In some embodiments, the photo-stable product of the photochemically active dye can be an oxidation product of DAEOHₒ. In some embodiments of the present invention, the photochemically active dye on reaction with the singlet oxygen may form photo-stable decomposition products.

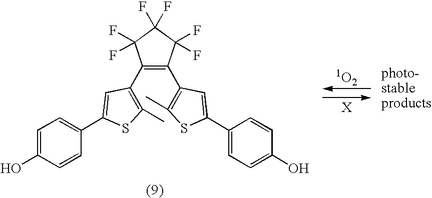

Further, the oxidized reaction products of the open and closed form diarylethylenes do not under go transformation reaction with respect to each other. Hence the holographic data written (optically readable datum) is preserved.

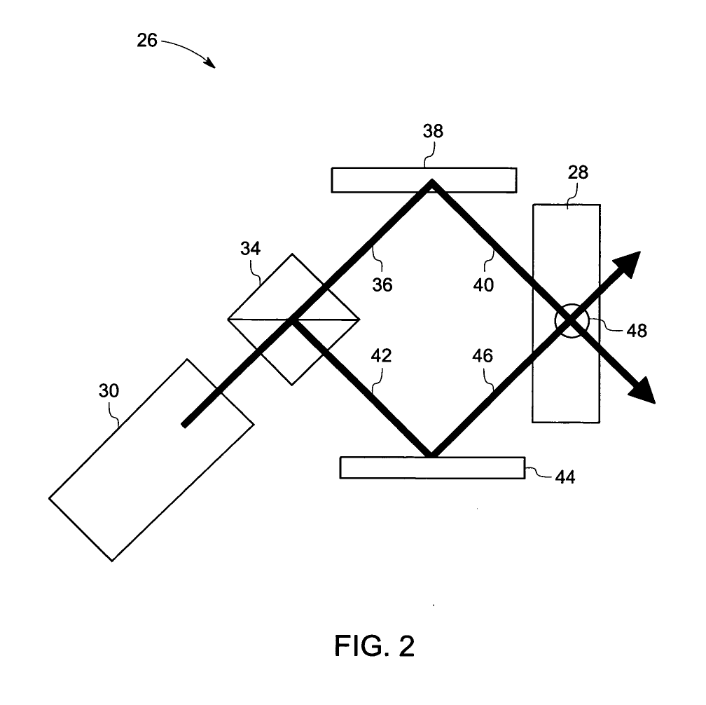

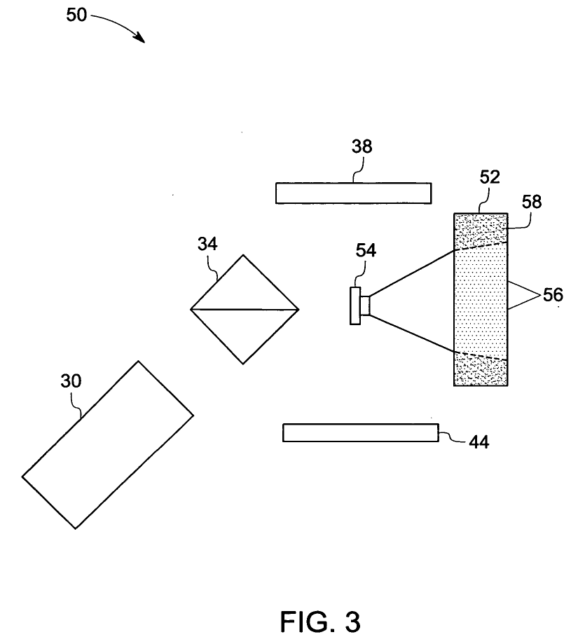

An example of a suitable holographic data storage method to create and stabilize holographic data is shown in FIGS. 2 and 3. The illustrated embodiment for holographic storage shown in FIGS. 2 and 3 is shown using a page-based holographic data storage system 26, but the method is equally applicable for bit-wise holographic storage. In the holographic data writing configuration as shown in FIG. 2, the output from a laser 30 is divided into two equal beams by a beam splitter 34. A first beam, 36, is incident on a modulator such as but not limited to spatial light modulator (SLM) or deformable mirror device (DMD) 38, and data to be stored is encoded on to the beam to provide a signal beam 40. Such modulators typically include a number of pixels that can block or transmit the light based upon input electrical signals. Each pixel can represent a bit or a part of a bit (a single bit may consume more than one pixel of the SLM or DMD) of data to be stored. The signal beam 40 is then incident on the storage medium 28. A second beam 42 is incident on a mirror 44 and the reflected beam, reference beam 46, is incident on storage medium 28 with minimal distortion. The two beams are coincident on the same area 48 of the storage medium 28 at different angles. The superposition of the two beams, 40 and 46 creates an interference pattern at their intersection. The dye within the holographic storage medium undergoes a photochemical change that results in a modification of the refractive index in the region exposed to the interfering laser beams, and consequently the interference pattern that is created is “written” into the holographic storage medium, effectively creating a grating in the storage material 28.

FIG. 3 illustrates a process for enhancing the lifetime of holographic data in one embodiment of the present invention. As described above, enhancing the lifetime of data may involve stabilizing a photo-product and/or stabilizing a photochemically active dye. Holographic data may be stabilized using a light source 54. In one embodiment, the light source may be a collimated source and in another embodiment, the light source may be a diffuse source. In some embodiments, the light source may be an incoherent source, and in other embodiments, the light source may be a coherent source. In one embodiment, only a portion 56 of the holographic storage medium 52 may be subjected to the stabilization process by exposure to light from the light source 54 leaving an unstabilized portion 58. In another embodiment, the entire holographic storage medium 52 may be exposed to light from the light source 54. In some embodiments, the light source 54 may be integral to the holographic data storage system 50. In other embodiments, the light source may be external to the holographic data storage system 50. In some embodiments, the laser source 30 may be a frequency doubled laser system, where light at a frequency doubled wavelength may be used to write data and light at a fundamental wavelength may be used to stabilized the datum. In one embodiment the stabilization process may be conducted in the presence of atmospheric oxygen. In another embodiment, the stabilization process may be conducted in the presence of an oxygen enriched atmosphere. It should be noted, that in certain embodiments, the light source 54 is located on the opposite side (relative to that shown in the figure) of the holographic storage medium 52.

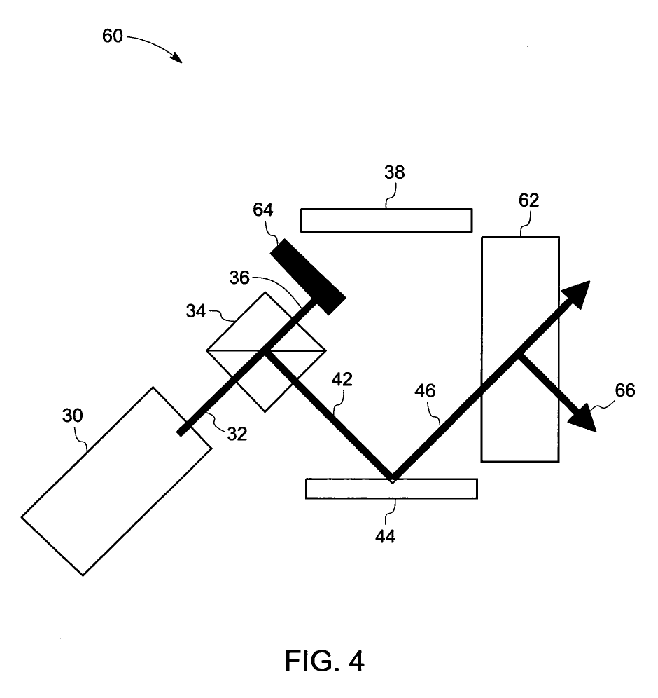

In one embodiment of the present invention, a method for reading holographic data is shown in FIG. 4, using a system 60. For reading the holographic data, the system configuration is similar to the writing configuration shown in FIG. 2, but further includes the use of a signal blocking device such as a shutter 64 to block the first beam 36, emerging from the beam splitter 34. The grating or pattern created in a holographic storage medium 62 is exposed to the reference beam 46 in the absence of any interfering beam by blocking the first beam 36 with a shutter 64 and the data is reconstructed using the recreated signal beam 66. In one embodiment, the read wavelength is the same as the write wavelength. In some embodiments, the power of the reference beam used for readout is typically about 2-3 orders of magnitude smaller than that used at recording.

In another embodiment of the present invention is a holographic data storage medium including an optically transparent substrate comprising an optically transparent plastic material, and at least one photo-stable product of a photochemically active dye. The first photo-stable product results from an oxidation reaction of a photo-product resulting from a photochemical conversion of the photochemically active dye during the storage of data as a hologram.

In some embodiments to enhance data storage efficiency the wavelength for writing does not coincide with the maximum absorption of the dye material. This enables the addition of substantially more dye into the holographic storage medium but still maintains a manageable absorption coefficient such that the data is accurately stored. The proper amount can be determined as a function of the maximum absorption of the dye. For example, if the peak absorption is such that only 1% of the light at the same wavelength is a transmitted, the write wavelength can be chosen away from the peak such that the material transmits from about 25% to about 75% of the incident light. In some cases, the transmission can range from about 40% to about 60%, with a transmission of about 50% present in some other embodiments.

As one skilled in the art will appreciate, different molecules will have widely differing absorption profiles (broader, narrower, etc.). Thus, the wavelengths utilized for writing and reading the holographic storage media of the present disclosure will depend upon the light source, the substrate, and the dye material. Wavelengths suitable for writing data into the holographic storage media can vary depending upon both the substrate and dye material used, and can range from about 375 nm to about 550 nm, preferably from about 400 nm to about 540 nm.

In another embodiment, is another method for manufacturing a holographic data storage medium. The method includes incorporating a photochemically active dye and a singlet oxygen generator into the organic polymer in a mixing process to form a data storage composition. Following the mixing process, the data storage composition is molded into an article that can be used as holographic data storage media. Examples of molding can include injection molding, blow molding, compression molding, vacuum forming, or the like. The molded article can have any geometry. Examples of suitable geometries are circular discs, square shaped plates, polygonal shapes, or the like. The thickness of the articles can vary, from being at least 100 micrometers in an embodiment, and at least 1000 micrometers in another embodiment.

The mixing processes by which the photochemically active dye and the singlet oxygen generator can be incorporated into the organic polymer can involve the use of shear force, extensional force, compressive force, ultrasonic energy, electromagnetic energy, thermal energy or combinations comprising at least one of the foregoing forces or forms of energy and is conducted in equipment wherein the aforementioned forces are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, baffles, or combinations comprising at least one of the foregoing.

Mixing can be conducted in machines such as a single or multiple screw extruder, a Buss kneader, a Henschel® mixer, a helicone, an Eirich® mixer, a Ross® mixer, a Banbury® mixer, a roll mill, molding machines such as injection molding machines, vacuum forming machines, blow molding machine, or then like, or a combination comprising at least one of the foregoing machines. Alternatively, the dye and the optically transparent plastic material may be dissolved in a solution and films of the optically transparent substrate can be spin cast from the solution.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLE 1

All handling of the compounds described is performed under protection from light or under red-light conditions. 2 g optical quality PMMA (poly(methyl methacrylate)) is dissolved in 10 ml of dichloromethane. 2 ml of this solution is placed in an amber vial and 3 mg of the singlet oxygen sensitizer, ZnNa (zinc 2,11,20,29-tetra-tert-butyl-2,3-naphthalocyanine, CAS Number 39049-43-9, Aldrich Chemical Co.) with structural formula as shown in (X) is added and dissolved. Finally 2 mg of DAEOHₒ (1,2-bis[5′-(4″-hydroxyphenyl)-2′-methylthien-3′-yl]perfluorocyclopentene) with structural formula (VI) is added and dissolved. The mixture is then solvent cast onto a glass slide to form a film of about 100 micron thickness and the film is dried under a mild vacuum for 24 hours.

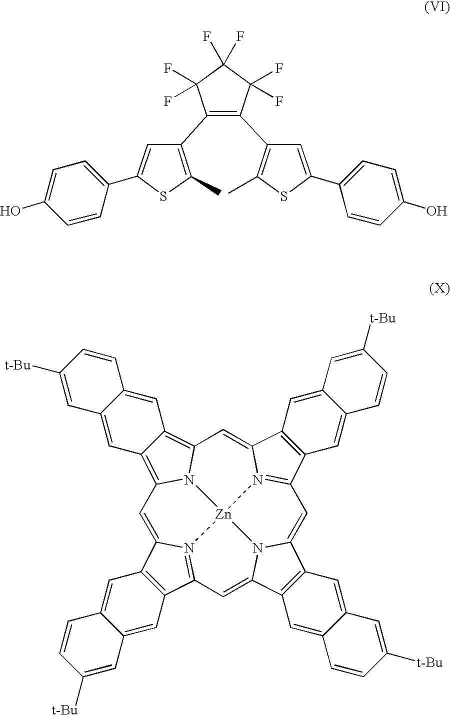

A planewave hologram is written into the dried film by using a 405 nm set-up with a diffraction efficiency of 1%. A plane wave hologram is a recorded interference pattern produced by a signal beam and a reference beam. The signal and reference are both planewaves that have the same power and beam size, incident at the same location on the sample, polarized in the same direction and coherent to each other. Thereafter, the reading beam is focused onto the hologram and the diffraction efficiency is monitored. The diffraction efficiency decays towards zero within a control time period, t₁.

### EXAMPLE 2

An identical film sample is prepared as described above in EXAMPLE 1 and a hologram is written at 405 nm in an identical manner to the one described earlier. The written datum is exposed for 1 hour under an atmosphere of oxygen to an unfocused laser beam of 780 nm light (100 mW over a 5 mm area containing the hologram written into the medium at 405 nm). Next, the decay of the hologram is monitored by using a 405 nm reading laser beam. The beam is focused onto the hologram and the diffraction efficiency is monitored. The diffraction efficiency at time t₁ is higher than that observed for the control.

### EXAMPLE 3

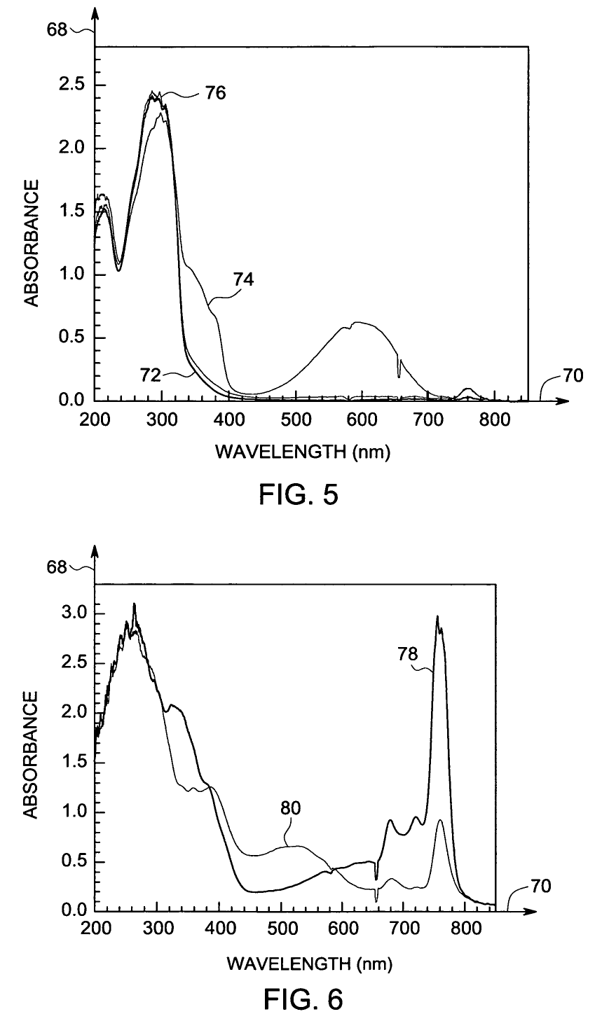

A solution (sample A) in acetonitrile solvent of an open form diarylethene (1,2-bis[5′-(4″-hydroxyphenyl)-2′-methylthien-3′-yl]-perfluorocyclopentene, DAEOHₒ, structural formula (VI)) was prepared. FIG. 5 shows the variation in absorbance (Y-axis 68) with wavelength (X-axis 70), before and after exposure to 405 nm bleaching radiation. Absorption profile 72 was measured before exposure to bleaching radiation. Sample A was then subjected to a bleaching radiation at a wavelength of 405 nm for 9 minutes. Absorbance versus wavelength profile 74 was again measured. Profile 74 displays a prominent peak at about 600 nm, which was not observed in the absorption profile 72 before the bleaching exposure, indicating the presence of a photo-product as a result of the bleaching exposure. Although the Applicants do not wish to be bound by any particular theory, it is believed that upon exposure to bleaching radiation at 405 nm, the open form diarylethene (DAEOHₒ) undergoes a cyclization reaction to form a closed form diarylethene (DAEOH_{c}) (photo-product). The bleaching process at 405 nm was followed by a bleaching process at 532 nm. Profile 76 in FIG. 5 illustrates the variation in absorption with wavelength after the 5 minute bleaching exposure at 532 nm. It is seen that profiles 72 and 76 overlap, indicating that upon bleaching at 532 nm, the closed form diarylethene reverts to the open form diarylethene. This example illustrates that a cyclization reaction of an open form diarylethene (a “DAEₒ”) to a closed form diarylethene (a “DAE_{c}”) can be initiated using light of 405 nm wavelength, which can be used to store rewritable holographic data. This example illustrates further that illumination with light of 532 nm wavelength initiates the conversion from the closed form diarylethene to the open form diarylethene, which can erase the written holographic data.

A solution (sample B) in acetonitrile solvent of a closed form diarylethene (1,2-bis[5′-(4″-hydroxyphenyl)-2′-methylthien-3′-yl]-perfluorocyclopentene, DAEOH_{c}, structural formula (VII)) was prepared and ZnNa was added. Sample B was subjected to a bleaching exposure at a wavelength of 780 nm for 15 minutes to generate singlet oxygen. FIG. 6 shows the variation in absorbance (Y-axis 68) with wavelength (X-axis 70) before and after exposure to bleaching radiation at 780 nm. Absorption profiles 78 and 80 were measured before and after exposure to bleaching radiation at 780 nm. After bleaching at 780 nm, the solution exhibits decreased absorption at both 600 nm and 780 nm. Although the Applicants do not wish to be bound by any particular theory, it is believed that upon exposure to bleaching radiation at 780 nm, the photosensitized ZnNa enables the generation of singlet oxygen which reacts with the closed form diarylethene (DAEOH_{C}), oxidizing the DAEOH_{C} to DAEO_{C}, which is expected to be stable against irradiation at 532 nm, which would otherwise lead to the reversal of the cyclization of DAEOH_{C}.

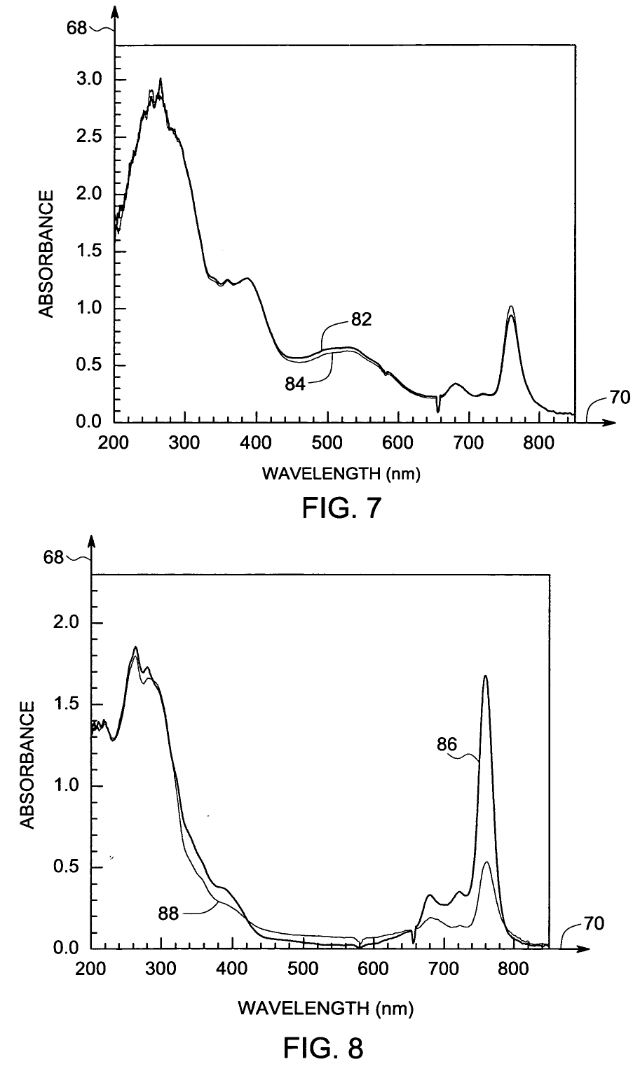

To determine whether or not sample B is stable against irradiation at 532 nm after the bleaching at 780 nm, the solution was subjected to an additional bleaching exposure at 532 nm for 10 minutes. Absorbance versus wavelength profiles 82 and 84, before and after bleaching at 532 nm are shown in FIG. 7, exemplifying that bleaching at 532 nm has negligible effect on the sample, pointing to the formation of a photo-stable product (DAEO_{C}).

A solution (sample C) in acetonitrile solvent of an open form diarylethene (1,2-bis[5′-(4″-hydroxyphenyl)-2′-methylthien-3′-yl]-perfluorocyclopentene, DAEOHₒ) and ZnNa, was prepared. The solution was subjected to a bleaching radiation at 780 nm for 5 minutes followed by a bleaching exposure to radiation at 405 nm. FIG. 8 shows the absorbance versus wavelength profiles 86 and 88, before and after bleaching exposure to radiation at a wavelength of 780 nm followed by exposure to 405 nm. Although the Applicants do not wish to be bound by any particular theory, it is believed that upon exposure to bleaching radiation at 780 nm, the photosensitized ZnNa enables the generation of singlet oxygen which reacts with the open form diarylethene (DAEOH_{O}), oxidizing the DAEOH_{O}, which is expected to be stable against radiation at 405 nm. The example exemplifies stabilizing the open form diarylethene.

The holographic data storage methods and articles described herein above have many advantages, including, providing holographic data storage with enhanced data storage lifetime leading to greater commercial viability of such photochemically active dye based holographic storage mediums.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for storing holographic data, said method comprising:
step (A) providing an optically transparent substrate comprising a photochemically active dye and a singlet oxygen generator;
step (B) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and
step (C) activating the optically transparent substrate to generate singlet oxygen to stabilize the optically readable datum.

2. The method of claim 1, wherein the activating step is accomplished by photo-activating at a second wavelength and an intensity sufficient to generate singlet oxygen, wherein the singlet oxygen reacts with the photo-product and/or the photochemically active dye to stabilize the optically readable datum.

3. The method of claim 1, wherein the activating step is accomplished by thermally activating with thermal energy sufficient to generate singlet oxygen, wherein the singlet oxygen reacts with the photo-product and/or the photochemically active dye to stabilize the optically readable datum.

4. The method of claim 1, wherein the photo-product comprises a photo-decomposition product, a product of oxidation, a product of reduction, a product of bond breaking, or a molecular rearrangement product.

5. The method of claim 1, wherein the photo-product comprises a photo-stable decomposition product, a photo-stable product of oxidation, a photo-stable product of reduction, a photo-stable product of bond breaking, or a photo-stable molecular rearrangement product.

6. The method of claim 1, wherein the photochemically active dye is a dye material selected from the group consisting of vicinal diarylethene, nitrones, nitrostilbenes and combinations thereof.

7. The method of claim 1, wherein the photochemically active dye is a vicinal diarylethene selected from the group consisting of diarylperfluorocyclopentenes, diarylmaleic anhydrides, diarylmaleimides and combinations thereof.

8. The method of claim 1, wherein the photochemically active dye is a vicinal diarylethene, wherein the vicinal diarylethene has a structure (I) 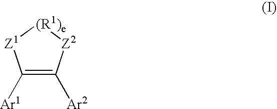
wherein “e” is 0 or 1; R¹ is a bond, an oxygen atom, a substituted nitrogen atom, a sulfur atom, a selenium atom, a divalent C₁-C₂₀ aliphatic radical, a halogenated divalent C₁-C₂₀ aliphatic radical, a divalent C₃-C₂₀ cycloaliphatic radical, a halogenated divalent C₁-C₂₀ cycloaliphatic radical, or a divalent C₂-C₃₀ aromatic radical; Ar¹ and Ar² are each independently a C₂-C₄₀ aromatic radical, or a C₂-C₄₀ heteroaromatic radical; and Z¹ and Z² are independently a bond, a hydrogen atom, a monovalent C₁-C₂₀ aliphatic radical, divalent C₁-C₂₀ aliphatic radical, a monovalent C₃-C₂₀ cycloaliphatic radical, a divalent C₃-C₂₀ cycloaliphatic radical, a monovalent C₂-C₃₀ aromatic radical, or a divalent C₂-C₃₀ aromatic radical.

9. The method of claim 1, wherein the photochemically active dye has structure (VI):

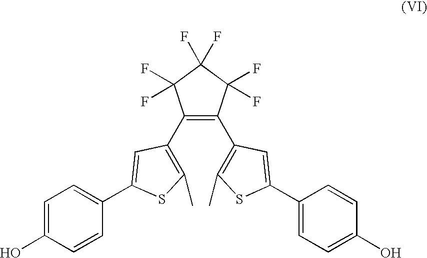

10. The method of claim 1, wherein the photochemically active dye is present in an amount from about 0.1 to about 10 weight percent, based on the total weight of the optically transparent substrate.

11. The method of claim 1, wherein the singlet oxygen generator comprises a compound selected from the group consisting of singlet oxygen sensitizers, singlet oxygen precursors, and combinations thereof.

12. The method of claim 11, wherein the singlet oxygen generator comprises a singlet oxygen sensitizer selected from the group consisting of methylene blue, azulene, rose bengal, 2′-acetonaphthone, naphthalene, naphthalene derivatives, phthalocyanine, phthalocyanine derivatives, naphthalocyanine, naphthalocyanine derivatives, porphine, porphine derivatives, anthracene, anthracene derivatives, and combinations thereof.

13. The method of claim 11, wherein the singlet oxygen generator comprises a singlet oxygen precursor selected from the group consisting of naphthalene endoperoxides and anthracene endoperoxides, 1,4-disubstituted naphthalene peroxide, and N,N′-di(2,3-dihydroxypropyl)-1,4-naphthalenedipropanamide. 9,10-diphenylanthracene peroxide, 1,4,-diphenylanthracene peroxide, and combinations thereof.

14. The method of claim 1, wherein the singlet oxygen generator is present in a molar quantity greater than or equal to the molar quantity of the photochemically active dye.

15. The method of claim 1, wherein the optically transparent substrate comprises an optically transparent plastic material.

16. The method of claim 1, wherein the optically transparent substrate comprises a thermoplastic polymer, a thermosetting polymer, or a combination of a thermoplastic polymer and a thermosetting polymer.

17. The method of claim 16, wherein the thermoplastic polymer comprises a polycarbonate.

18. The method of claim 1, wherein the first wavelength is selected to be in a range from about 300 nanometers to about 800 nanometers.

19. The method of claim 1, wherein a UV-visible absorbance of the photochemically active dye is in a range between about 0.1 and about 1 at a wavelength in a range between about 300 nanometers and about 550 nanometers.

20. The method of claim 2, wherein the second wavelength is selected to be in a range from about 300 nm to about 1500 nm, wherein the second wavelength is not equal to the first wavelength, and wherein the absorption of the photochemically active dye at the second wavelength is less than about 0.1.

21. The method of claim 2, wherein the second wavelength is selected to be in a range from about 300 nm to about 1500 nm, wherein the second wavelength is longer than the first wavelength, and wherein the absorption of the photochemically active dye at the second wavelength is less than about 0.1.

22. The method of claim 1, wherein the optically transparent substrate is at least 100 micrometers thick.

23. A method of manufacturing a holographic data storage medium, the method comprising:
forming a film of an optically transparent substrate comprising an optically transparent plastic material, a photochemically active dye, and a singlet oxygen generator.

24. The method of claim 23, wherein the optically transparent substrate is at least 100 micrometers thick; and comprises the photochemically active dye in an amount corresponding to from about 0.1 to about 10 weight percent based on a total weight of the optically transparent substrate, and has a UV-visible absorbance in a range from about 0.1 to 1 at a first wavelength selected to be in a range from about 300 nanometers to about 800 nanometers, wherein the singlet oxygen generator is present in a molar quantity equal to or greater than a molar quantity of the photochemically active dye present.

25. The method of claim 23, wherein the film of the optically transparent substrate is formed by a molding technique.

26. The method of claim 23, wherein the film of the optically transparent substrate is formed by a spin casting technique.

27. The method of claim 23, wherein the optically transparent plastic material comprises a thermoplastic polymer, a thermosetting polymer, or a combination of a thermoplastic polymer and a thermosetting polymer.

28. A holographic data storage medium comprising:
an optically transparent plastic material;
a photochemically active dye; and
a singlet oxygen generator.

29. A data storage medium having at least one optically readable datum stored therein, the data storage medium comprising:
an optically transparent plastic material;
a photochemically active dye;
a singlet oxygen generator;
a photo-product derived from the photochemically active dye;
a photo-stable product derived from the photochemically active dye, the photo-product, or combinations thereof; and
wherein the optically readable datum is stored as a hologram patterned within at least one volume element of the optically transparent substrate.

30. An optical writing/reading method, comprising:
step (A) irradiating with a holographic interference pattern an optically transparent substrate that comprises a photochemically active dye and a singlet oxygen generator, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing a first optically readable datum corresponding to the volume element; wherein the holographic interference pattern is produced by simultaneously irradiating the optically transparent substrate with two interfering beams at the first wavelength;
step (B) activating the optically transparent substrate to generate singlet oxygen to stabilize the optically readable datum; and
step (C) irradiating the optically transparent substrate with a read beam and reading the optically readable datum by detecting diffracted light.

31. The method of claim 30, wherein the two interfering beams comprise a signal beam corresponding to data and a reference beam that does not correspond to data.

32. The method of claim 30, wherein the activating comprises photo-activating at a second wavelength and an intensity sufficient to generate singlet oxygen to stabilize the optically readable datum.

33. The method of claim 30, wherein the read beam has a wavelength that is shifted by 1 nanometer to about 400 nanometers from the signal beam's wavelength.

34. The method of claim 30, wherein the first wavelength, the second wavelength and the read beam all have different wavelengths.
